(19) United States
(12) Patent Application Publication
(10) Pub. No.: US 2014/0053254 A1
(43) Pub. Date: Feb. 20, 2014

(54) GRAPHICAL AUTHENTICATION SYSTEM AND METHOD FOR ANTI-SHOULDER SURFING ATTACK

(71) Applicant: INDUSTRIAL TECHNOLOGY RESEARCH INSTIT, Hsin-Chu (TW)

(72) Inventors: Hung-Min Sun, Hsinchu (TW); Chia-Yun Cheng, Hsinchu County (TW)

(73) Assignee: INDUSTRIAL TECHNOLOGY RESEARCH INSTITUTE, Hsin-Chu (TW)

(21) Appl. No.: 13/677,078

(22) Filed: Nov. 14, 2012

(30) Foreign Application Priority Data
Aug. 17, 2012 (TW) 101129890

(51) Int. Cl. H04L 9/32

(52) U.S. Cl. 726/7

(57) ABSTRACT

The present disclosure relates to a graphical authentication system and the method of the same for anti-shoulder surfing attack, With the system and method, the user is able to select a graph form a graph list, The selected graph is partitioned into M*N pieces of graph blocks, Further, one of the graph blocks is selected to generate a password, when login, the system and method create randomly a login hint to indicate a position, the user therefore scroll a set of horizontal bar and vertical bar to the position according to the login hint and confirm entry, the system and method further proceed a authentication process to verify the entry to determine the validity of the authentication.

### CROSS REFERENCE TO RELATED APPLICATION

The present application is based on, and claims priority from, Taiwan (International) Application Serial Number 101129890, filed on Aug. 17, 2012, the disclosure of which is hereby incorporated by reference herein in its entirety.

### TECHNICAL FIELD

The present disclosure relates to a graphical authentication system and method for anti-shoulder surfing attacking.

### TECHNICAL BACKGROUND

In computer security, a conventional authentication is an authentication process that verifies an identity by requiring correct authentication information to be provided. The authentication information is usually a password made up of random numbers and letters. With rapid advance in Internet technology and popularity, there are a variety of web services and web applications that are becoming available in recent decade. Nevertheless, for gaining access to a website, a user is generally required to become a registered member of the website, and only then the user is able to login to the website using his/her registered username and password so as to have access to the service of the website. Generally, a user will use a same pair of username and password to register and login to different web service systems, and more particularly, a simple password composed of a pure string of numbers or lowercase English characters, as shown in FIG. 1A, is used in those web services so as to process the corresponding authentication processes rapidly and correctly. However, such simple password with weak password strength may not be very effective in resisting attacker using either brute-force attacks or dictionary attack.

Nowadays, with the rise in popularity of portable Internet devices, it is a common practice for users to gain access to computer systems with cloud computing service in public. However, as these devices are often used in places that are more public and less secure and since most login information for authentication is provided and inputted into the corresponding authentication system either by typing on keyboard or by touching touch panel, the login information that is being provided in public can be very vulnerable to simple spying or “shoulder-surfing”. That is, any person with malicious intent can watch or photograph an unsuspecting user sign into his or her account, and thus, the user's privacy and property security are endangered.

In recent year, there are many different types of authentication systems and methods that are becoming available on the market, such as the graphical authentication system. However, asking users to remember a password consisting of a “mix of uppercase and lowercase characters” is similar to asking them to remember a sequence of bits, which is hard to remember, and only a little bit harder to crack. Therefore, there are biometrics-based authentication systems, such as the fingerprint recognition system, the iris recognition system, etc., that are provided and designed to perform an authentication process based on unalterable personal characteristics without asking users to memorize their passwords at all time. However, such biometrics-based authentication system is not popular for its poor portability; owing to they usually require to be assisted by some additional auxiliary devices so as to perform adequately. Thus, the knowledge-based authentication systems are still the mainstream authentication systems used today, despite that they are vulnerable to simple shoulder-surfing attack.

There are already many studies focusing on solving such security issues. One of which is disclosed in a U.S. Patent Application, entitled “Apparatus and Method for Inputting User Password”, in which the password characters displayed on the password input interface are determined by a series of character sets such as personal identification number (PIN) so as to be used for preventing shoulder-surfing attack. In this U.S. patent, a user will be asked to register a password composed of a string of alphanumeric characters while defining a respective target color for each character in the string, prior to an authentication process. For instance, a PIN number “531” is selected and accordingly yellow color is defined to be the target color for the digit “5”, the light-brown color is defined to be the target color for the digit “3”, and the purple color is defined to be the target color for the digit “1”. Please refer to FIG. 1B, which is a schematic diagram showing a conventional password input interface. When an authentication process is performed, a skin image of a password input interface is displayed, and on which a plurality of targets and a plurality of password characters are arranged at random. Consequently, the user is required to move the target colors using direction keys for enabling the registered target and the registered password character to be positioned at the same coordinate as that of the skin image so as to successfully complete the authentication process. That is, the user may perform the input by putting one character of the password character string on the password input interface to the target and by pressing an enter button. For example, in a case where yellow color is assigned to a target and a password is set as the number of 5, the authentication success message may be confirmed when the input button is pressed.

Another such study is an authentication method disclosed in U.S. Patent Application, entitled “Graphical Image Authentication and Security System”. During the enrollment phase of this authentication method, the user will be required to select a series of one or more image categories, which will serve as the user's authentication sequence. Thereafter, during the authentication process, an image series including the images of the user's authentication sequence will be generated and displayed, such as the nine images shown in FIG. 1C, whereas the location of the categories in the series is randomized, and the specific image for each category is chosen randomly from a database of images for that specific category. Each image will be overlaid with a unique randomly generated image key. The user will select the image on the series according to the at least one preselected category. Optionally, the user may select a plurality of image identifiers corresponding to the user's preselected categories in their authentication sequence by entering the image key overlaid on the images. For instance, if the image identifiers corresponding to the user's preselected categories is “three” and “strawberry”, the image keys overlaid on these two images, i.e. “E3”, are entered, as shown in FIG. 1C.

Therefore, it is in need of a graphical authentication system, which adopts a one-time login indicator for guaranteeing the security of protecting the user password from shoulder surfing attacking

### TECHNICAL SUMMARY

The present disclosure provides a graphical authentication system for anti-shoulder surfing attacking, which comprises:
an image discretization module, for partitioning a graph selected by a user into M*N pieces of graph blocks while allowing the user to selected one graph block from the M*N pieces of graph blocks based upon their respectively graphical features to be used as a password for authenticating the identity of the users;
a login indicator generator module, for providing a randomly generated login indicator;
a horizontal and vertical axis control module, to be operated by the user during the password authenticating for controlling the scroll of a horizontal bar and a vertical bar;
a communication module, for controlling the data transmission between a server and other modules in the graphical authentication system;
   a password verification module, for verifying a password inputting by the user; and
a database, doe storing account information relating to the user;
wherein, the horizontal bar is composed of M horizontal components of distinctive features; and the vertical bar is composed of N vertical components of distinctive features, and the login indicator is composed of one horizontal component and one vertical component that are respectively selected from the M horizontal components and the N vertical components.

The present disclosure also provides a graphical authentication method for anti-shoulder surfing attacking, which comprises the steps of:
inputting a sole username to a service by a user;
enabling the user to select a graph from a graph list, or enabling the user to fetch a graph from a storage media while uploading the graph to the service;
enabling the selected graph to be partitioned into M*N pieces of graph blocks by the service;
enabling the user to select one of the graph blocks and use as a base for generating a password;
storing the username, the selected graph and the selected graph block into a database;
enabling the service to create a horizontal bar, being composed of M horizontal components of distinctive features, and a vertical bar, being composed of N vertical components of distinctive features, while enabling the service during a login process enabled by the user to randomly generate a login indicator composed of one horizontal component and one vertical component that are respectively selected from the M horizontal components and the N vertical components;
enabling the user to scroll the horizontal bar and the vertical bar to a position according to the login indicator and confirm entry;
enabling the service to perform an evaluation to determine whether information that is indicated by and corresponding to the position is conforming to the information stored in the database; and
allowing the user to log into the service if the information is conforming.

With the aforesaid method and system, the security of protecting the user password from shoulder surfing attacking can be guaranteed.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1A is a schematic diagram showing a conventional password composed of a pure string of numbers or lowercase English characters.

FIG. 1B is a schematic diagram showing a conventional password input interface.

FIG. 1C is a schematic diagram showing another conventional password input interface.

FIG. 2 is a block diagram showing a graphical authentication system according to an exemplary embodiment of the present disclosure.

FIG. 3A is a flow chart depicting the steps performed in a registration phase according to an exemplary embodiment of the present disclosure.

FIG. 3B is a schematic diagram showing how a user is to obtain a login indicator according to an exemplary embodiment of the present disclosure.

FIG. 4 are schematic diagrams showing three graphs being partitioned respectively into three sets of M*N pieces of graph blocks according to an exemplary embodiment of the present disclosure.

FIG. 5 is a schematic diagram showing how a user is to obtain a login indicator according to another exemplary embodiment of the present disclosure.

FIG. 6 is a schematic diagram showing a horizontal bar and a vertical bar used in an exemplary embodiment of the present disclosure.

FIG. 7A and FIG. 7B are schematic diagrams showing the performing of an authentication process by a user according to an exemplary embodiment of the present disclosure.

FIG. 8 is a flow chart depicting the steps performed in an authentication phase according to an exemplary embodiment of the present disclosure.

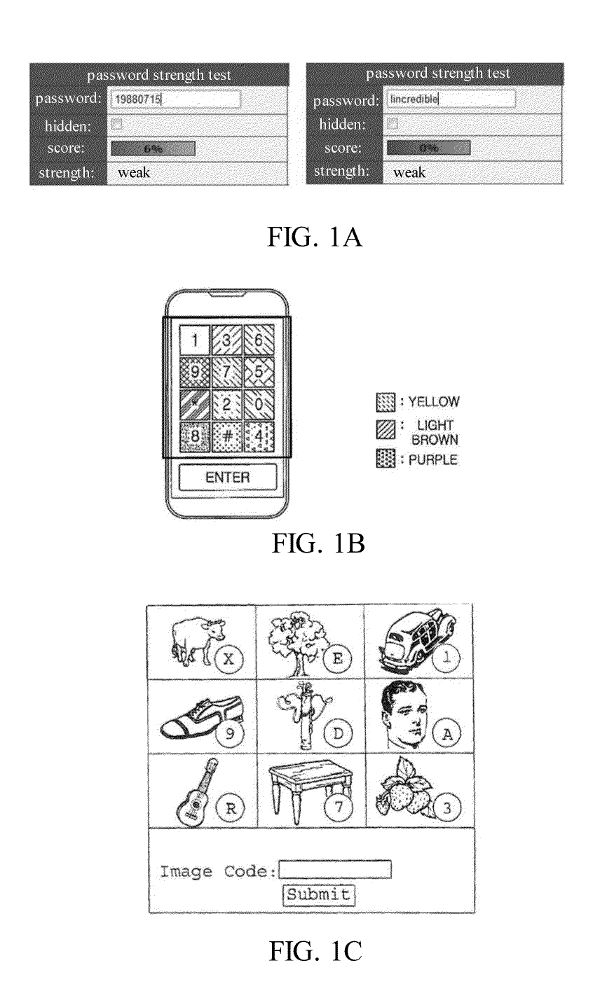

### DESCRIPTION OF THE EXEMPLARY EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

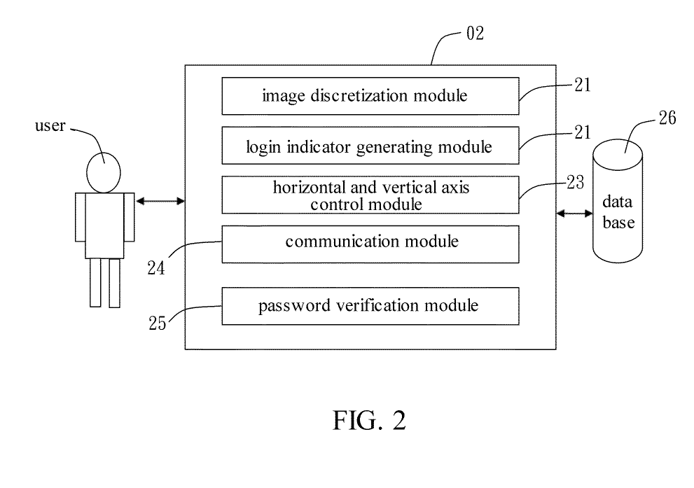

Please refer to FIG. 2, which is a block diagram showing a graphical authentication system according to an exemplary embodiment of the present disclosure. As shown in FIG. 2, the graphical authentication system 02 comprises: an image discretization module 21, a login indicator generating module 22, a horizontal and vertical axis control module 23, a communication module 24, a password verification module 25 and a database 26.

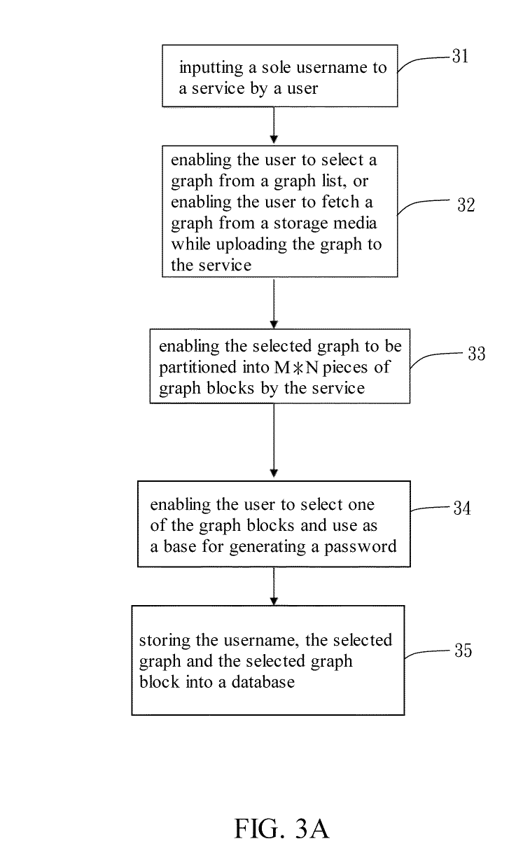

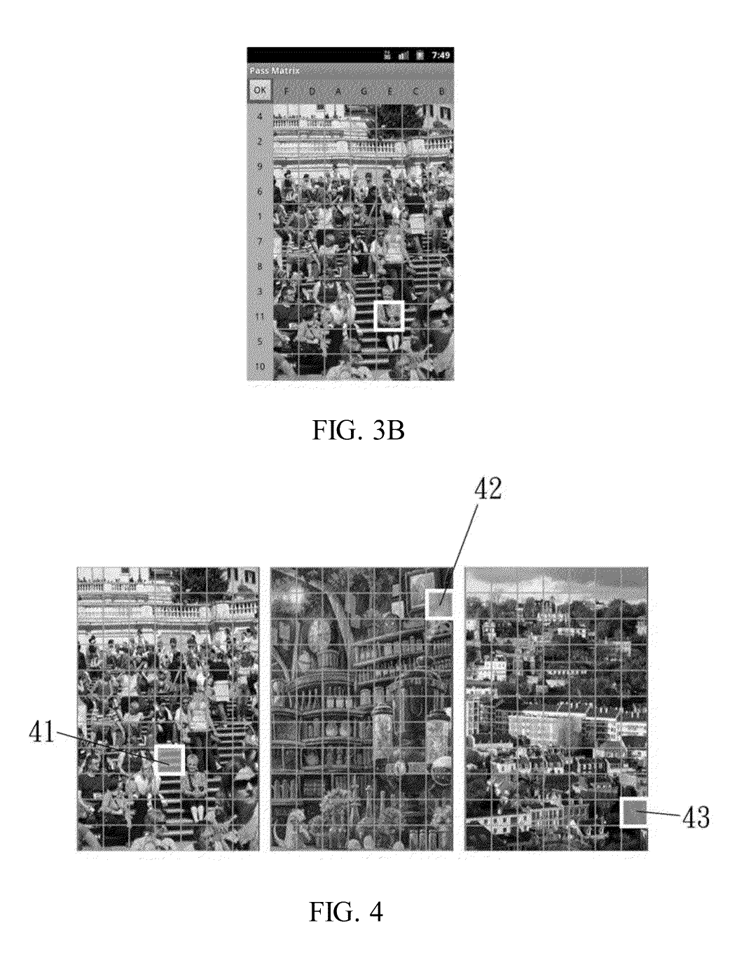

It is noted that before initiating the graphical authentication system and method of the present disclosure, a registration process must be performed by a user in advance. As shown in FIG. 3, the registration process comprises the steps of:

step 31: inputting a sole username to a service by a user;

step 32: enabling the user to select a graph from a graph list, or enabling the user to fetch a graph from a storage media while uploading the graph to the service;

step 33: enabling the selected graph to be partitioned into M*N pieces of graph blocks by the service;

step 34: enabling the user to select one of the graph blocks and use as a base for generating a password; and

step 35: storing the username, the selected graph and the selected graph block into a database.

Accordingly, it is clear that during the registration, the user can either select one graph or more than one graph that is to be partitioned, and then select one graph block out of the plural graph blocks resulting from the partition to be used as a base for creating a login indicator. In an embodiment shown in FIG. 3B, the selected graph is being partitioned into a 7*11 array of graph blocks, and the graph block showing a water bottle handing by a women at of column 9, row 5 is being specified to be the position where the login indicator can be obtained, and thereby, by consulting to the horizontal bar and the vertical bar, both with randomly arranged alphanumeric labels, that are created by the login indicator generating module 22, the so-obtained login indicator is (E, 11).

As shown in FIG. 4, there are three graphs being selected by the user and then each being partitioned by the image discretization module 21 into M*N pieces of graph blocks, i.e. a 7*11 array as shown in FIG. 4. Thereafter, the user is able to select one graph block from each of the three graphs to be used for generating a password. That is, if there are three graphs being selected by the user and partitioned by the image discretization module 21, there will be three graph blocks being selected respectively from the three graphs to be used in the generating of password, as the graph blocks 41, 42 and 43 shown in FIG. 4. Similarly, the horizontal bar and the vertical bar of this graphical authentication system will both be formed with randomly arranged alphanumeric labels. Taking the embodiment shown in FIG. 4 for example, there are three graphs and the corresponding three graph blocks 41, 42 and 43 that are selected are located at a position of column 8, row 4 of the first graph, a position of column 2, row 7 of the second graph, and position of column 10, row 7 of the third graph, that can be referred respectively as block (8,4) at graph A, block (2,7) at graph B and block (10,7) at graph C hereinafter. Thus, during the registration process, the service that is to be logged in will first generate a login indicator relating to the graph A in a random manner, which can be C5 for instance, and then the graph A is displayed on the service while having a horizontal bar and a randomly generated vertical bar that are both randomly generated to overlay on the graph A. Thereby, the user is able to scroll the horizontal bar and the vertical bar to a position of the selected graph block according to the login indicator of graph A and confirm entry. Thereafter, the service is enabled to generate a login indicator relating to the graph B in a random manner, which can be B7 for instance, and then the graph B is displayed on the service while having a horizontal bar and a randomly generated vertical bar that are both randomly generated to overlay on the graph C. Thereby, the user is able to scroll the horizontal bar and the vertical bar to a position of the selected graph block according to the login indicator of graph B and confirm entry. Then, the service is enabled to generate a login indicator relating to the graph C in a random manner, which can be E11 for instance, and then the graph C is displayed on the service while having a horizontal bar and a randomly generated vertical bar that are both randomly generated to overlay on the graph C. Thereby, the user is able to scroll the horizontal bar and the vertical bar to a position of the selected graph block according to the login indicator of graph C and confirm entry. After correctly accomplishing the aforesaid steps, the user then is able to login to the service successfully.

In the aforesaid embodiment of the present disclosure, each graph is partitioned into 7*11 pieces of graph blocks. Nevertheless, it is not limited thereby and thus the numbers M and N can be determined according to the security requirement of the service. That is, the finer the graph being partitioned, the more the graph block will be resulted, and consequently, the password strength for resisting brute-force attack is increased. However, for those devices with comparatively smaller screens, it is difficult for a user to recognize a graph block when the graph is being partitioned into too many graph blocks. Thus, it is importance to take the screen size into consideration for determining the numbers M and N in the graphical authentication system and method of the present disclosure. The embodiment shown in FIG. 4 is an example of a smart phone with smallest screen, where the graph is partitioned every other 60 pixels horizontally and vertically. As shown in FIG. 4, the graph can be partitioned into a two-dimensional array of graph blocks arranged in a Cartesian coordinate system having a horizontal axis and a vertical axis. However, it is not limited thereby, and thus the graph can be partitioned into a one-dimensional array of graph blocks arranged in a Cartesian coordinate system having either a single horizontal axis or a single vertical axis.

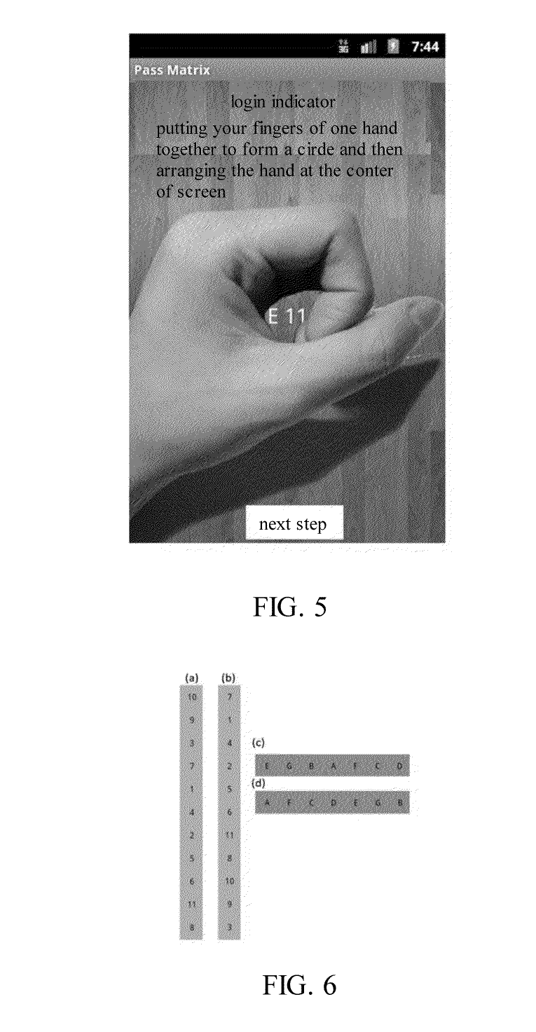

The login indicator generating module is used for providing a randomly generated login indicator, whereas the login indicator is composed of a horizontal component and a vertical component. In an embodiment of the present disclosure, the horizontal bar is labeled by horizontal components of English letters and the vertical bar is labeled by vertical components of numbers, and thus, each login indicator is the composition of one English letter and one number, such as (A, 3) and (E, 11). It is noted that both the horizontal component and the vertical component in one login indicator are generated randomly, and thus, the login indicators that are obtained at different times even for the same user will not be the same. In addition, the login indicator can be provided to and obtained by the user in different ways without any restriction. For instance, the login indicator can be an audio signal that can be heard by the user via the transmission of a headset, or the login indicator can be a video signal that can be displayed on a display device after the user putting his/her fingers of one had together to form a circle and then arranging the hand to engage with the screen by a side thereof, whereas the displaying of the video signal is discontinued after the hand is detached from the screen, as shown in FIG. 5.

The horizontal and vertical axis control module is enabled during the performing of a password verification process by a user, which is provided for enabling the horizontal bar and the vertical bar to be controlled by the user according to the function programmed in the horizontal and vertical axis control module. Moreover, the horizontal bar is composed of M horizontal components of distinctive features; and the vertical bar is composed of N vertical components of distinctive features. In an embodiment of the present disclosure, the M horizontal components of the horizontal bar are English letters, and the N vertical components of the vertical bar are numbers, by that at each time when the vertical and the horizontal bars are generated, the English letters on the horizontal bar as well as the numbers of the vertical bar are randomly arranged. Moreover, each of the vertical and the horizontal bars is designed to scroll in circles. As shown in FIG. 6, when the line (a) of the vertical bar is scrolled up by 3 units, the number 10 that was originally disposed at the top of the line (a) will reappear from the bottom of the line (a) and then move upwardly like a rotating tires by 3 units, as shown in line (b) of FIG. 6. By the cooperation of this horizontal bar and the vertical bar, the position of the selected graph block can be indicated by the corresponding login indicator.

The communication module is used for controlling the data transmission between a server and other modules in the graphical authentication system, and the data being transmitted by the communication module includes the graphs and the graph block that are selected by the user during the registration process. It is noted that any such data transmission by the communication module is protected by the SSL (Secure Socket Layer) protocol so as to prevent the data transmission from being monitored or acquired by any person with malicious intent.

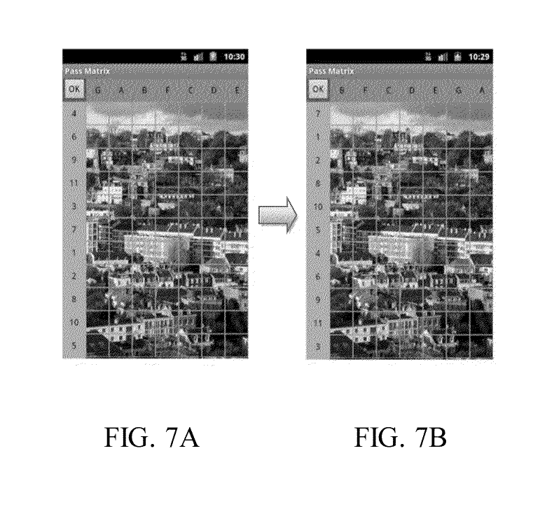

The password verification module is used for verifying a password inputting by the user in the password verification process, whereas the password inputting into the service can be performed in an indirect manner. It is noted that only after each and every graph and its corresponding graph block that are selected by the user during the registration process are inputted correctly as required by the service, the user is then able to succeed in the password verification process and then to be allow to login to the service. For instance, the graph shown in FIG. 7A is selected by a user during registration, and the graph block that is selected for creating login indicator is the one located at row 5 and column 10. Consequently, when the obtained login indicator is (E, 11), the user will have to scroll the horizontal bar and thus move the English letter “E” to row 5, and also scroll the vertical bar and thus move the number “5” to column 10 so as to confirm entry.

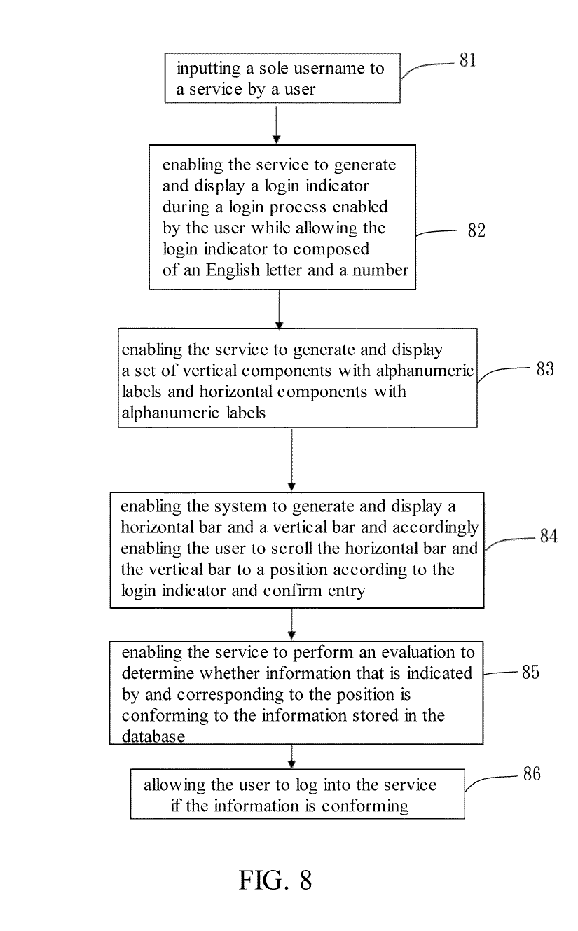

In addition, as shown in FIG. 8, the password verification process comprises the steps of”

step 81: inputting a sole username to a service by a user;

step 82: enabling the service to generate and display a login indicator during a login process enabled by the user while allowing the login indicator to composed of an English letter and a number;

step 83: enabling the service to generate and display a set of vertical components with alphanumeric labels and horizontal components with alphanumeric labels;

step 84: enabling the system to generate and display a horizontal bar and a vertical bar and accordingly enabling the user to scroll the horizontal bar and the vertical bar to a position according to the login indicator and confirm entry;

step 85: enabling the service to perform an evaluation to determine whether information that is indicated by and corresponding to the position is conforming to the information stored in the database; and

step 86: allowing the user to log into the service if the information is conforming.

In addition, the database is used for storing account information relating to the user, whereas the account information of the user may include a username of the user, and information relating to the password of the user (such as the image number of the selected graph, the grid position of the selected graph), and the registration time of the user, login records, and the duration of each login, and so on. Moreover, the database can be adapted for a system with functions including add, delete and search, etc.

The system and method of the present disclosure can be adapted for various of service platform. While being adapted for web applications, the system and method of the present disclosure can be achieved using various web-related techniques, which includes: style sheet language, such as HyperText Markup Language (HTML) and Cascading Style Sheets (CCS); techniques for facilitating client-server communication in a non-synchronous manner, such as Ajax (Javascript+XML); and various data manipulation languages, such as PHP and MySQL. On the other hand, While being adapted for applications on Android or OS, the system and method of the present disclosure can be achieved using Java and Android API.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A graphical authentication system for anti-shoulder surfing attacking, comprising:
an image discretization module, for partitioning a graph selected by a user into M*N pieces of graph blocks while allowing the user to selected one graph block from the M*N pieces of graph blocks based upon their respectively graphical features to be used as a password for authenticating the identity of the users;
a login indicator generator module, for providing a randomly generated login indicator;
a horizontal and vertical axis control module, to be operated by the user during a password verification process for controlling the scroll of a horizontal bar and a vertical bar;
a communication module, for controlling the data transmission between a server and other modules in the graphical authentication system;
a password verification module, for verifying a password inputting by the user in the password verification process; and
a database, for storing account information relating to the user;
wherein, the horizontal bar is composed of M horizontal components of distinctive features; and the vertical bar is composed of N vertical components of distinctive features, and the login indicator is composed of one horizontal component and one vertical component that are respectively selected from the M horizontal components and the N vertical components.

2. The graphical authentication system of claim 1, wherein there can be more than one graphs to be selected by the user.

3. The graphical authentication system of claim 1, wherein each of the horizontal component is a component selected from the group consisting of: an English letter, a number, a color and an icon; and each of the horizontal component are a component selected from the group consisting of: an English letter, a number, a color and an icon.

4. The graphical authentication system of claim 1, wherein the graph can be partitioned into a two-dimensional array of graph blocks arranged in a Cartesian coordinate system having a horizontal axis and a vertical axis; and the graph can be partitioned into a one-dimensional array of graph blocks arranged in a Cartesian coordinate system having either a single horizontal axis or a single vertical axis.

5. The graphical authentication system of claim 1, wherein both the horizontal component and the vertical component in the login indicator are generated in a random manner; and the login indicator is an audio signal that can be heard by the user via the transmission of a headset, or the login indicator can be a video signal that can be displayed on a display device after the user putting his/her fingers of one had together to form a circle and then arranging the hand to engage with the screen by a side thereof, whereas the displaying of the video signal is discontinued after the hand is detached from the screen.

6. The graphical authentication system of claim 1, wherein the password verifying performed by the password verification module further comprises the steps of:
enabling a service to generate and display a login indicator during a login process enabled by the user while the login indicator is composed of an English letter and a number;
enabling the service to generate and display a set of a vertical components with alphanumeric labels and horizontal components with alphanumeric labels;
enabling the system to generate and display a horizontal bar and a vertical bar and accordingly enabling the user to scroll the horizontal bar and the vertical bar to a position according to the login indicator and confirm entry;
enabling the service to perform an evaluation to determine whether information that is indicated by and corresponding to the position is conforming to the information stored in the database; and
allowing the user to log into the service if the information is conforming.

7. The graphical authentication system of claim 1, wherein the account information of the user includes a username of the user, and information relating to the password of the user which includes the image number of the selected graph, the grid position of the selected graph, and the registration time of the user.

8. The graphical authentication system of claim 1, wherein the service can be adapted for a cellular phone or a computer.

9. A graphical authentication method for anti-shoulder surfing attacking, comprising the steps of:
enabling the user to select a graph from a graph list, or enabling the user to fetch a graph from a storage media while uploading the graph to a service;
enabling the selected graph to be partitioned into M*N pieces of graph blocks by the service;
enabling the user to select one of the graph blocks and use as a base for generating a password;
storing a username of the user, the selected graph and the selected graph block into a database;
enabling the service to create a horizontal bar, being composed of M horizontal components of distinctive features, and a vertical bar, being composed of N vertical components of distinctive features, while enabling the service during a login process enabled by the user to randomly generate a login indicator composed of one horizontal component and one vertical component that are respectively selected from the M horizontal components and the N vertical components;
enabling the user to scroll the horizontal bar and the vertical bar to a position according to the login indicator and confirm entry;
enabling the service to perform an evaluation to determine whether information that is indicated by and corresponding to the position is conforming to the information stored in the database; and
allowing the user to log into the service if the information is conforming.

10. The graphical authentication method of claim 9, wherein there can be more than one graphs to be selected by the user.

11. The graphical authentication method of claim 9, wherein each of the horizontal component is a component selected from the group consisting of: an English letter, a number, a color and an icon; and each of the horizontal component is a component selected from the group consisting of: an English letter, a number, a color and an icon.

12. The graphical authentication method of claim 9, wherein the graph can be partitioned into a two-dimensional array of graph blocks arranged in a Cartesian coordinate system having a horizontal axis and a vertical axis; and the graph can be partitioned into a one-dimensional array of graph blocks arranged in a Cartesian coordinate system having either a single horizontal axis or a single vertical axis.

13. The graphical authentication method of claim 9, wherein both the horizontal component and the vertical component in the login indicator are generated in a random manner; and the login indicator is an audio signal that can be heard by the user via the transmission of a headset, or the login indicator can be a video signal that can be displayed on a display device after the user putting his/her fingers of one had together to form a circle and then arranging the hand to engage with the screen by a side thereof, whereas the displaying of the video signal is discontinued after the hand is detached from the screen.

14. The graphical authentication method of claim 9, wherein the account information of the user includes a username of the user, and information relating to the password of the user which includes the image number of the selected graph, the grid position of the selected graph, and the registration time of the user.

15. The graphical authentication method of claim 9, wherein the service can be adapted for a cellular phone or a computer.
